(19) United States
(12) Patent Application Publication
(10) Pub. No.: US 2016/0283124 A1
(43) Pub. Date: Sep. 29, 2016

(54) MULTI-STREAMED SOLID STATE DRIVE

(71) Applicant: KABUSHIKI KAISHA TOSHIBA, Tokyo (JP)

(72) Inventors: Daisuke HASHIMOTO, Cupertino, CA (US); Shinichi KANNO, Ota Tokyo (JP)

(21) Appl. No.: 15/065,465

(22) Filed: Mar. 9, 2016

Related U.S. Application Data
(60) Provisional application No. 62/138,315, filed on Mar. 25, 2015.

(51) Int. Cl. G06F 3/06; G06F 12/02

(52) U.S. Cl. CPC G06F 3/0605; G06F 3/061; G06F 3/0616; G06F 3/064; G06F 3/0652; G06F 3/0659; G06F 3/0679; G06F 12/0246; G06F 2212/1016; G06F 2212/1036; G06F 2212/214; G06F 2212/7201; G06F 2212/7205

(57) ABSTRACT

A storage device includes a nonvolatile semiconductor memory device including a plurality of physical blocks, and a controller configured to map the physical blocks and access the physical blocks based on mapping thereof. The controller maps a physical block having space, as a first input block for writing data associated with a first identifier, another physical block having space, as a second input block for writing data associated with a second identifier, a physical block that became full of data associated with the first identifier, as a first active block, a physical block that became full of data associated with the second identifier, as a second active block, and a physical block that became full of invalid data associated with the first identifier and a physical block that became full of invalid data associated with the second identifier, as free blocks associated with no identifier.

### CROSS-REFERENCE TO RELATED APPLICATION

This application is based upon and claims the benefit of priority from U.S. Provisional Patent Application No. 62/138,315, filed Mar. 25, 2015, the entire contents of which are incorporated herein by reference.

### FIELD OF THE INVENTION

This invention generally relates to a storage system including a host and a storage device, in particular, a storage system that operates to write data according to a stream identifier.

### BACKGROUND

NAND-flash-based solid-state drives (SSDs) have become common in different types of computing devices because of its low power consumption and high performance. A multi-streamed SSD has been proposed as a way to improve the performance of SSDs. In a multi-streamed SSD, write commands issued by a host are executed according to stream identifiers (IDs) that the host appends to the write commands according to the expected lifetime of write data. Instead of storing the write data in any available physical block, the multi-streamed SSD stores the write data in physical blocks selected according to their stream IDs. As a result, data with similar expected lifetimes can be stored together in the same physical block and separated from other data with different expected lifetimes. Over time, as data are deleted, the multi-streamed SSD will experience less fragmentation within the physical blocks that still contain valid data than a conventional SSD. The result is a more streamlined garbage collection process and a reduction in write amplification, and ultimately longer SSD life.

In the multi-streamed SSD of the related art, which is disclosed in Kang et al., “The Multi-streamed Solid-State Drive,” Proceedings of the 6th USENIX Conference on Hot Topics in Storage and File Systems, Jun. 17-18, 2014, pp. 13-13, stream IDs are employed to separate system data and workload data, in particular workload from the Cassandra NoSQL DB application. In one implementation disclosed in the paper, system data were assigned stream ID ‘0’ and the workload data were assigned stream ID ‘1’. In another implementation disclosed in the paper, the system data were assigned stream ID ‘0’ and the different types of data generated by the workload were given different stream IDs. Use of up to four different steam IDs were explored and benefits in the form of lower garbage collection overhead and increased overall drive throughput were published.

### DESCRIPTION OF THE DRAWINGS

FIG. 1 illustrates a computer system that implements multi-streaming in a host and a drive, according to embodiments.

FIG. 2 illustrates four examples of a stream ID management table stored in and managed by the host, according to the embodiments.

FIG. 3 illustrates an example of a block-to-stream (B2S) map stored in and managed by the drive according to the embodiments.

FIG. 4 illustrates two units of a flash translation layer (FTL) map stored in and managed by the drive according to the embodiments.

FIG. 5 schematically illustrates a single stream shared by multiple namespaces and a single namespace shared by multiple streams.

FIG. 6 illustrates an example of a group definition table stored in and managed by the drive according to the embodiments.

FIG. 7 is a flow diagram of steps performed by an operation system (OS) in the host, in response to a write command received from an application (or alternatively, thread or VM).

FIG. 8 is a flow diagram of steps performed by the drive in response to a write 10 received from the host.

FIGS. 9-12 each illustrate an example of data flow and block management architecture in the drive.

FIG. 13 is a flow diagram of steps performed by the drive, when the drive receives a command to delete a stream.

FIG. 14 is a flow diagram of steps performed by the drive, when the drive receives a command to group steams.

FIG. 15 is a flow diagram of steps performed by the drive, when the drive receives a command to streams into a stream.

### SUMMARY

A storage device according to embodiments implements additional features that further streamline the garbage collection process, reduce write amplification, and extend the life of the SSD.

According to an embodiment, a storage device includes a nonvolatile semiconductor memory device including a plurality of physical blocks, and a controller configured to map the physical blocks and access the physical blocks based on mapping thereof. The controller maps a physical block having space, as a first input block for writing data associated with a first identifier, another physical block having space, as a second input block for writing data associated with a second identifier, a physical block that became full of data associated with the first identifier, as a first active block, a physical block that became full of data associated with the second identifier, as a second active block, and a physical block that became full of invalid data associated with the first identifier and a physical block that became full of invalid data associated with the second identifier, as free blocks associated with no identifier.

According to another embodiment, a storage device includes a nonvolatile semiconductor memory device including a plurality of physical blocks, and a controller configured to map the physical blocks and access the physical blocks based on mapping thereof. The controller maps a physical block having space, as a first input block for writing data associated with a first identifier, another physical block having space, as a second input block for writing data associated with a second identifier, a physical block that became full of data associated with the first identifier and a physical block that became full of data associated with the second identifier, as active blocks associated with no identifier, and a physical block that became full of invalid data associated with the first identifier and a physical block that became full of invalid data associated with the second identifier, as free blocks associated with no identifier

According to another embodiment, a storage device includes a nonvolatile semiconductor memory device including a plurality of physical blocks, and a controller configured to map the physical blocks and access the physical blocks based on mapping thereof. The controller maps a physical block having space, as an input block for writing data associated with any identifiers that are mapped, a physical block that became full of data associated with said any identifiers, as an active block, and a physical block that became full of invalid data associated with said any identifiers as a free block.

### DETAILED DESCRIPTION

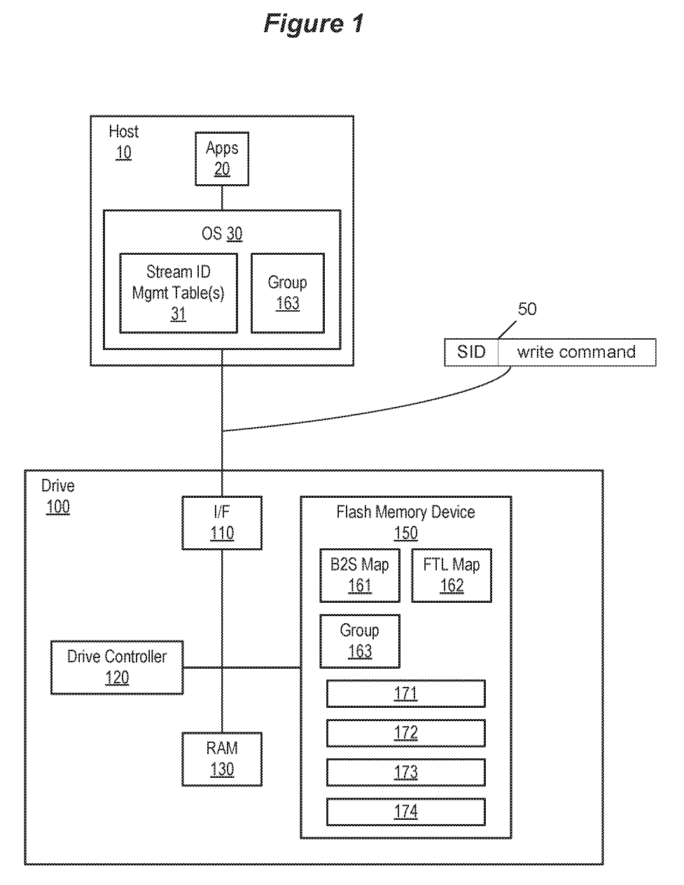

FIG. 1 illustrates a computer system (storage system) that implements multi-streaming in a host 10 and a drive 100, according to embodiments. Host 10 is a computer that has configured therein a file system driver, e.g., as part of an operating system (OS) 30, which may be a conventional operating system or an operating system for virtual machines commonly known as a hypervisor, to communicate with a multi-streamed SSD. The file system driver maintains one or more data structures, each referred to herein as a stream ID management table 31, used in assigning steam IDs to data included in write input-output operations (IOs) that are issued while applications (Apps) 20 are executed within host 10. Generally, a write IO includes data to be written (“write data”) and a write command that specifies a location for writing the write data, typically expressed as a logical block address (LBA), and the size of the write data.

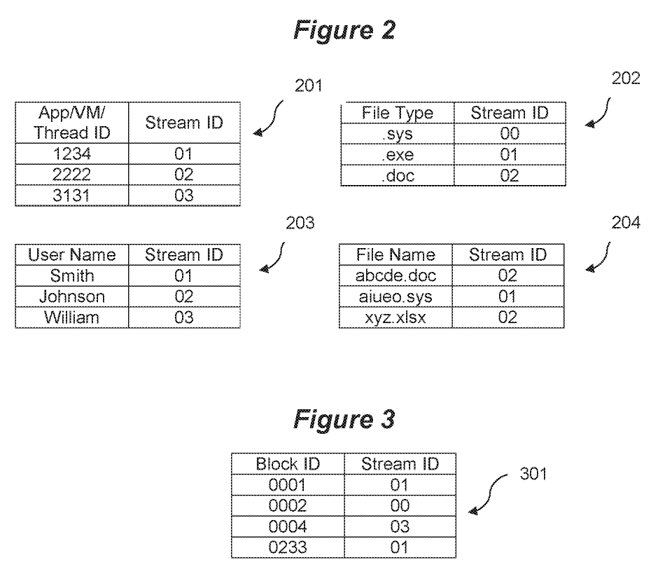

In one embodiment, the stream IDs are assigned based on an application ID of the application that causes the write IO to be generated, or a thread ID of a thread that causes the write IO to be generated. If the application is a virtual machine (VM), the stream IDs may be assigned based on a VM ID of the VM that causes the write IO to be generated. One example of stream ID management table 31 of this embodiment is depicted in FIG. 2 as table 201. According to table 201, if the VM that causes the write IO to be generated has VM ID ‘1234’, stream ID ‘01’ is assigned to the write IO and appended to the write command of the write IO. Similarly, if the VM that causes the write IO to be generated has VM ID ‘2222’, stream ID ‘02’ is assigned to the write IO and appended to the write command of the write IO. An example of a write command that has the stream ID (SID) appended thereto is shown in FIG. 1 as write command 50.

Instead of defining correspondence between the stream IDs and the application IDs (VM IDs or the thread IDs) in stream ID management table 31, the stream IDs may be assigned in accordance with a predetermined algorithm. For example, OS 30 of host 10 may operate to convert an application ID (VM ID or thread ID) to a numerical value using a hash function, and determines a remainder obtained by dividing the numerical value with the number of streams, as the stream ID. It is noted that host 10 knows the number of streams, because each of the streams is typically opened in accordance with a command from host 10. In this case, stream ID management table 31 may or may not be provided in host 10. If stream ID management table 31 is not provided, OS 30 operates to calculate a stream ID each time a write IO is issued. If stream ID management table 31 is provided, OS 30 may not use a stream ID that has been calculated previously and stored in stream ID management table 31.

In another embodiment, the stream IDs are assigned based on a file type (e.g., file extension) of the file for which the write IO is being issued. Different stream IDs are assigned to write IOs depending on the file type. One example of stream ID management table 31 of this embodiment is depicted in FIG. 2 as table 202. According to table 202, if the write IO is to be performed on a logical block of a file having an extension ‘.sys’, stream ID ‘00’ is assigned to the write IO and appended to the write command of the write 10. Similarly, if the write IO is to be performed on a logical block of a file having an extension ‘.doc’, stream ID ‘02’ is assigned to the write IO and appended to the write command of the write 10.

Instead of defining correspondence between the stream IDs and the file types in stream ID management table 31, the stream IDs may be assigned in accordance with a predetermined algorithm. For example, OS 30 of host 10 may operate to convert a file type (e.g. file extension) to a numerical value using a hash function, and determines a remainder obtained by dividing the numerical value with the number of streams, as the stream ID. It is noted that host 10 knows the number of streams, because each of the streams is typically opened in accordance with a command from host 10). In this case, stream ID management table 31 may or may not be provided in host 10. If stream ID management table 31 is not provided, OS 30 operates to calculate a stream ID each time a write IO is issued. If stream ID management table 31 is provided, OS 30 may not use a stream ID that has been calculated previously and stored in stream ID management table 31.

In another embodiment, the stream IDs are assigned based on a user name of a user who uses the application or the thread that causes the write IO to be generated. Different stream IDs are assigned to write IOs depending on the user name. One example of stream ID management table 31 of this embodiment is depicted in FIG. 2 as table 203. According to table 203, if the user name of a user who uses the application or the thread that causes the write IO is ‘Smith’, stream ID ‘01’ is assigned to the write IO and appended to the write command of the write IO. Similarly, if the user name of a user who uses the application or the thread that causes the write IO is ‘Johnson’, stream ID ‘02’ is assigned to the write IO and appended to the write command of the write 10.

Instead of defining correspondence between the stream IDs and the user names in stream ID management table 31, the stream IDs may be assigned in accordance with a predetermined algorithm. For example, OS 30 of host 10 may operate to convert a user name to a numerical value using a hash function, and determines a remainder obtained by dividing the numerical value with the number of streams, as the stream ID. It is noted that host 10 knows the number of streams, because each of the streams is typically opened in accordance with a command from host 10. In this case, stream ID management table 31 may or may not be provided in host 10. If stream ID management table 31 is not provided, OS 30 operates to calculate a stream ID each time a write IO is issued. If stream ID management table 31 is provided, OS 30 may not use a stream ID that has been calculated previously and stored in stream ID management table 31.

In another embodiment, the stream IDs are assigned based on a file name (including or without including its file extension) of the file for which the write IO is being issued. Different stream IDs are assigned to write IOs depending on the file name. One example of stream ID management table 31 of this embodiment is depicted in FIG. 2 as table 204. According to table 204, if the write IO is to be performed on a logical block of a file having a file name ‘abcde.doc’, stream ID ‘00’ is assigned to the write IO and appended to the write command of the write 10. Similarly, if the write IO is to be performed on a logical block of a file name ‘aiueo.sys’, stream ID ‘02’ is assigned to the write IO and appended to the write command of the write 10.

Instead of defining correspondence between the stream IDs and the file names in stream ID management table 31, the stream IDs may be assigned in accordance with a predetermined algorithm. For example, OS 30 of host 10 may operate to convert a file name to a numerical value using a hash function, and determines a remainder obtained by dividing the numerical value with the number of streams, as the stream ID. It is noted that host 10 knows the number of streams, because each of the streams is typically opened in accordance with a command from host 10). In this case, stream ID management table 31 may or may not be provided in the host 10. If stream ID management table 31 is not provided, OS 30 operates to calculate a stream ID each time a write IO is issued. If stream ID management table 31 is provided, OS 30 may not use a stream ID that has been calculated previously and stored in stream ID management table 31.

Drive 100 is a multi-streamed SSD according to embodiments. Drive 100 includes an interface (UF) 110 through which write IOs from host 10 are received and a drive controller 120 that manages the storing of data included in the write IOs in various storage regions of drive 100, including RAM 130, which is used as a temporary, non-persistent storage region, and flash memory device 150, which is used as a permanent, persistent storage region. When storing data in flash memory device 150, drive controller 120 refers to various data structures which are persistently maintained in flash memory device 150 and which may be cached in RAM 130. These data structures include B2S map 161 which provides a mapping of physical block number of flash memory device 150 to stream IDs, a flash translation layer (FTL) map 162, which provides a mapping of LBAs to physical block numbers for each of managed namespaces, and a group definition table 163, which tracks which stream IDs belong to which groups. Group definition table 163 is also maintained in OS 30 of host 10, and group definition table 163 in OS 30 and group definition table 163 in flash memory device 150 may be synchronized through data communication between host 10 and drive 100.

One example of the B2S map 161 is depicted in FIG. 3 as table 301. According to this mapping, physical blocks having block IDs ‘0001’ and ‘0233’ store data associated with stream ID ‘01’ and physical blocks having block IDs ‘0002’ and ‘0004’ store data associated with stream IDs ‘00’ and ‘03’, respectively. Further, in each entry of table 301, information indicating type of each block (such as input block, active block, and free block as described below) may be included. The B2S map 161 may or may not be embedded in the FTL Map 162.

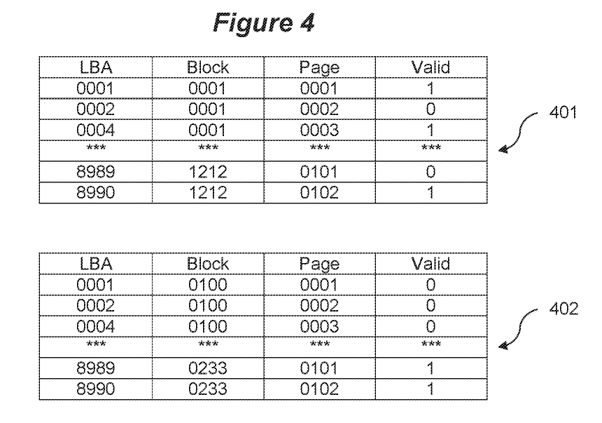

Examples of two FTL maps 162 are depicted in FIG. 4 as tables 401 and 402, each corresponding to a different namespace. As shown, the same LBA from different namespaces maps to different physical blocks of the flash memory device 150. FTL maps 162 as depicted in FIG. 4 also indicate on a per page basis whether the page is valid or invalid. It should be understood that each physical block of the flash memory device 150 contains a plurality of pages, and when data of a page are written, the corresponding valid flag is set to ‘1’ and when the data of the page are deleted, the corresponding valid flag is set to ‘0’. A garbage collection process is performed on a used block that has many invalid pages to “collect” the data of all valid pages of the used block into a free block by copying so that all data in the used block can be erased. It can be seen from FIG. 5 that LBAs from different namespaces can be mapped to physical blocks of flash memory device 150 having the same stream ID. As depicted in FIG. 5, a single stream may be shared by multiple namespaces and a single namespace may be shared by multiple streams.

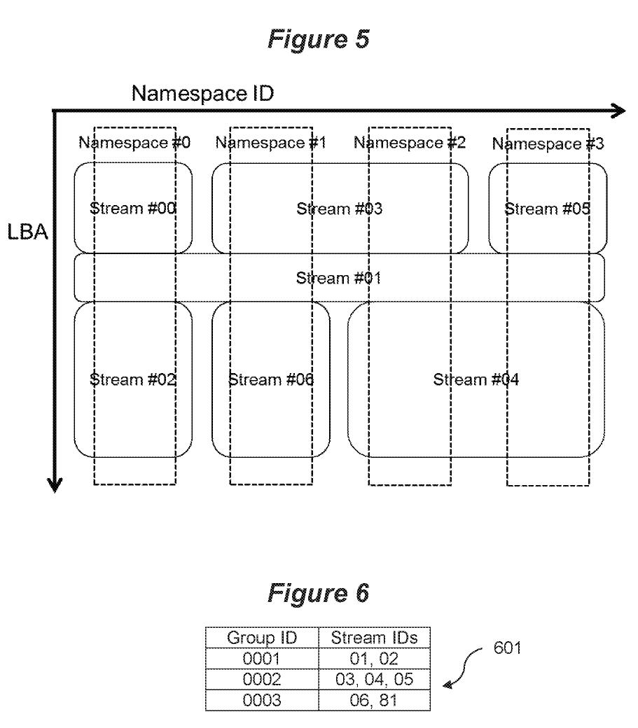

An example of the group definition table 163 is depicted in FIG. 6 as table 601. In table 601, stream IDs ‘01’ and ‘02’ belong to a logical group having group ID ‘0001’, while stream IDs ‘03’, ‘04’, and ‘05’ belong to a logical group having group ID ‘0002’ and stream IDs ‘06’ and ‘81’ belong to a logical group having group ID ‘0003’. In one embodiment, the logical grouping of stream IDs are defined by host 10 and communicated to drive 100 through an API which is further described below in conjunction with FIG. 14.

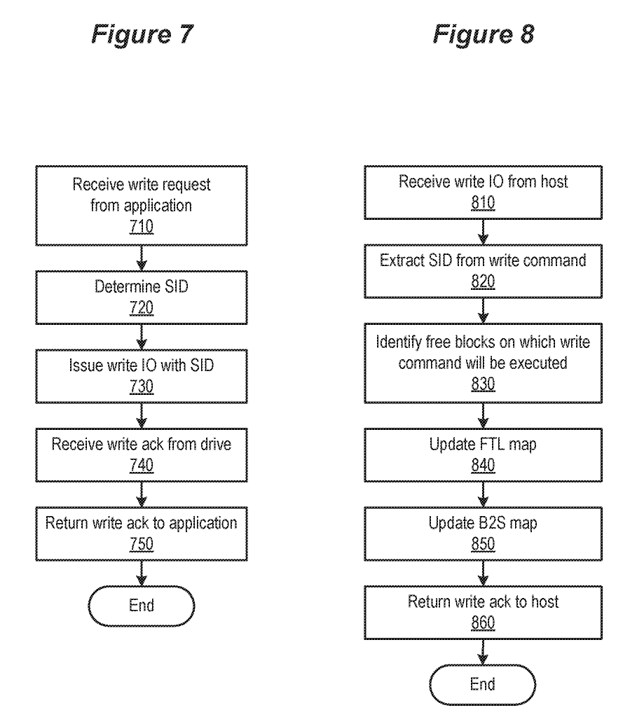

FIG. 7 is a flow diagram of steps performed by OS 30 in response to a write command received from an application (or alternatively, thread or VM). The method begins at step 710, when OS 30, in particular the file system driver of OS 30, receives the write request from the application. At step 720, OS 30 determines the stream ID (SID) to assign to the write request by consulting stream ID management table 31. At step 730, the file system driver issues to drive 100 a write 10 containing the data to be written and a write command having the stream ID appended thereto. Upon receiving a write acknowledgement from drive 100 at step 740, the file system driver returns the write acknowledgement to the application that requested the write at step 750.

FIG. 8 is a flow diagram of steps performed by drive 100 in response to a write 10 received from host 10. The method begins at step 810, when drive 100, in particular drive controller 120 of drive 100, receives the write 10 from host 10. Then, drive controller 120 extracts the stream ID from the write command (step 820) and consults a free block list to identify free blocks on which the write command will be executed (step 830). Upon storing the write data in the identified free block(s), drive controller 120 updates FTL map 162 at step 840 and B2S map 161 at step 850. In updating FTL map 162, drive controller 120 stores for each LBA spanned by the write, the physical block ID of the free block, the written page number, and a valid page flag of ‘1’ to indicate that the written page contains valid data. In updating B2S map 161, drive controller 120 stores for each free block identified, the physical block ID and the stream ID extracted at step 820. After the maps are updated, drive controller 120 returns a write acknowledgement to host 10 at step 860.

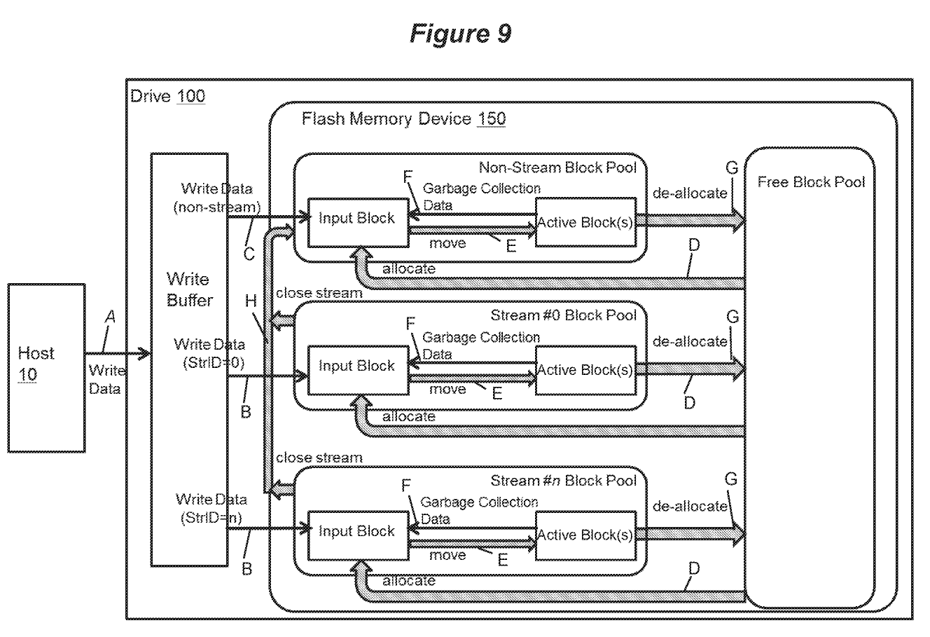

FIG. 9 shows an example of data flow and block management architecture of drive 100. Solid arrows indicate data flow of the write operation (and garbage collection), and arrows filled by gray-hatched pattern indicate state transitions of NAND flash memory blocks. When host 10 writes data to drive 100, drive controller 120 (not shown in FIG. 9) buffers data in a write buffer (arrow A in FIG. 9). Drive controller 120 identifies a stream ID of the buffered data using B2S Map 161 and FTL 162, and flushes (writes) the buffered data into an input block corresponding to the identified stream ID (arrow B in FIG. 9). If the stream ID is not identifiable by host 10, the data are flushed (written) into input blocks mapped in a non-stream block pool (arrow C in FIG. 9). If there is no available input block for storing the buffered data, drive controller 120 allocates a new input block from free block pool for the stream ID (arrows D in FIG. 9). When the input block is fully occupied by written data, then drive controller 120 moves the occupied input block to an active block pool corresponding to the stream ID (arrows E in FIG. 9). When drive controller 120 carries out garbage collection operation of flash memory device 150, drive controller 120 carries out data copy operation in each stream block pool using B2S Map 161 (arrows F in FIG. 9). When all data in an active block in the active block pool are invalidated through the garbage collection operation or an invalidation operation according to a trim command, drive controller 120 moves the invalidated active block to the free block pool (arrows G in FIG. 9). When host 10 sends a request to drive 100 to close a stream, drive controller 120 moves all of the blocks of the identified stream into the non-stream block pool (arrow H in FIG. 9).

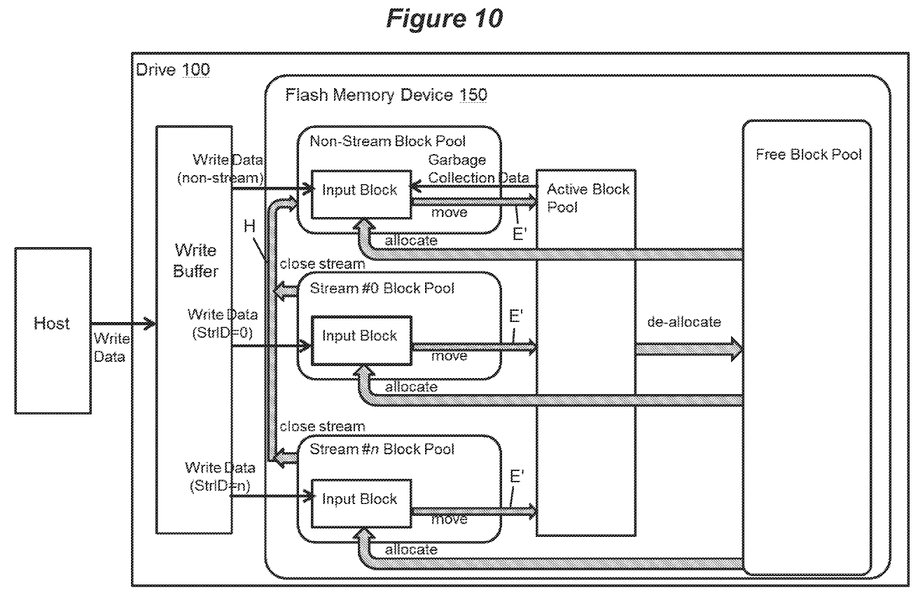

FIG. 10 shows another example of data flow and block management architecture of drive 100. In this example, the active block pool is shared by multiple streams (including the non-stream block pool). When drive controller 120 (not shown in FIG. 10) moves an input block to the active block pool (arrows E′ in FIG. 10), drive controller 120 removes or invalidates mappings from the input blocks to stream ID in B2S Map 161. That is, each of the input blocks, which is now remapped as an active block, is disassociated from the corresponding stream ID, and the active blocks no more have association with any stream IDs.

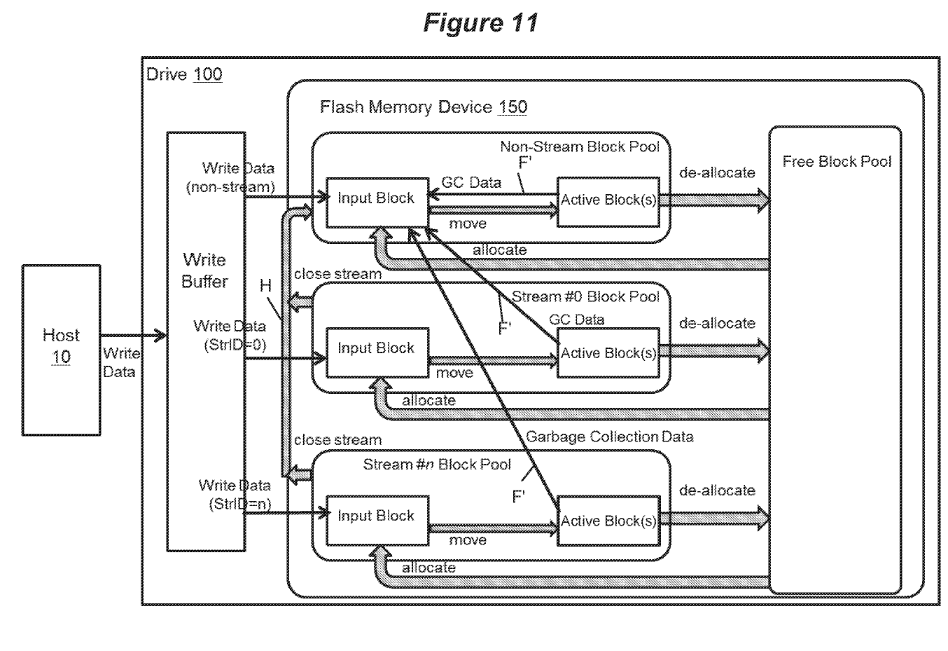

FIG. 11 shows another example of data flow and block management architecture of drive 100. In this example, the active block pool is separately provided for each stream initially, similarly to the example shown in FIG. 9, but when drive controller 120 (not shown in FIG. 11) carries out the garbage collection operation, drive controller 120 copies data of active blocks and transfer them to the input block of the non-stream block pool (arrow F′ in FIG. 11). That is, valid data collected from active blocks through garbage collection no longer have association with any stream IDs.

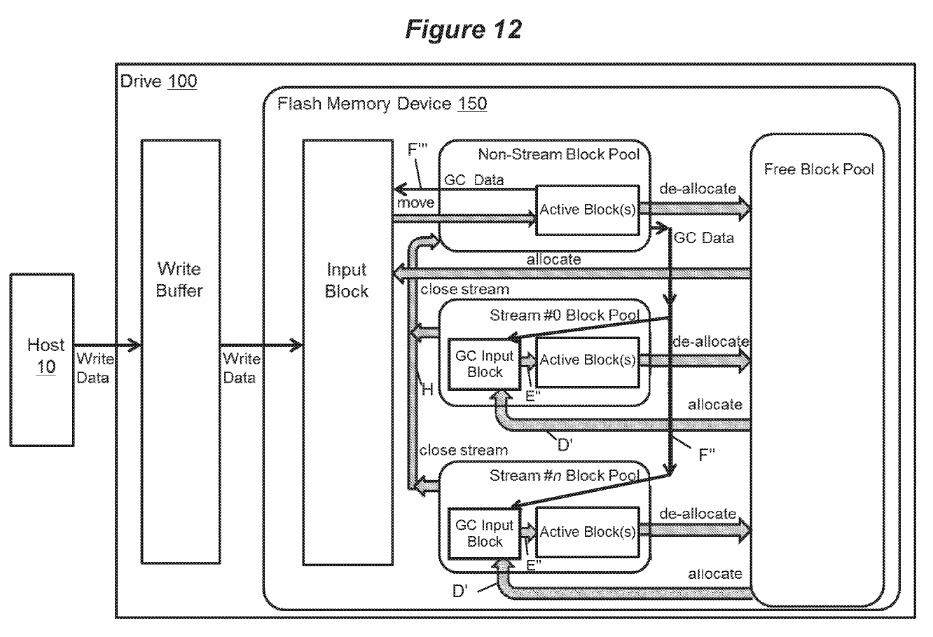

FIG. 12 shows another example of data flow and block management architecture of drive 100. In this example, the input block is shared by multiple streams while the active block pool is separately provided for each stream. All write data are flushed into the same input block, and the input block is moved to an active block in a non-stream block pool when the input block becomes full. Association of each write data with a stream ID is preferably mapped in a mapping table (not shown). Valid data in the active block are separately transferred to different input blocks (GC input blocks) associated with different stream IDs based on the stream ID associated with each of the valid data when the valid data in the active block are copied during the garbage collection (arrows F″ in FIG. 12). At this time, valid data associated with no stream ID are transferred to the input block (arrow F′″ in FIG. 12). When garbage collection is carried out on an active block associated with a stream ID, valid data in the active block are transferred to a GC input block associated with the same stream ID (arrows D′ in FIG. 12). When the GC input block is fully occupied by written data, then drive controller 120 moves the occupied GC input block to an active block pool corresponding to the stream ID (arrows E″ in FIG. 12).

Drive controller 120 of drive 100 supports a number of different APIs including an “open stream” API, a “close stream” API, a “get stream information” API, a “delete stream” API, a “group streams” API, a “merge streams” API, and a “start stream garbage collection” API.

The “open stream” API has a block class ID, as a parameter. The host 10 may issue the “open stream” API when host 10 attempts to open a new stream. In this case, drive controller 120 assigns a new stream ID, allocates an input block associated with the stream ID, and notifies the assigned stream ID to host 10. When the parameter “block class ID” equals to 0, a default class block is allocated as an input block, from the free block pool. When the parameter “block class ID” equals to 1, a SLC (Single Level Cell) block is allocated as the input block, from the free block pool. When the parameter “block class ID” equals to 2, a MLC (Multi Level Cell) block is allocated as the input block, from the free block pool. While access to the SLC block is faster than access to the MLC block and the SLC block has better reliability than the MLC block, the MLC block has higher capacity than the SLC block. The host 10 can manage access speed, reliability, and capacity by differentiating the value of the “block class ID”.

The “close stream” API has a stream ID, as a parameter. The host 10 may issue the “close stream” API when host 10 attempts to close an opened stream. In this case, drive controller 120 moves all blocks corresponding to the stream ID specified by the API into the non-stream block pool as shown by arrows H in FIGS. 9-12.

The “get stream information” API has a stream ID, as a parameter. The host 10 may issue the “get stream information” API when host 10 attempts to get information about a specific stream. In this case, for example, drive controller 120 returns data which include amount of blocks allocated to the specific stream, block class ID of the specific stream, a size of valid data associated with the specific stream, and a size of invalid data associated with the specific stream.

The “delete stream” API has a stream ID, as a parameter. The host 10 may issue the “delete stream” API when host 10 attempts to invalidate and/or delete all data associated with a particular VM, application, or user name, assuming that all write IOs from this VM, application, or user name were assigned the same stream number, by consulting steam ID management table 31, such as table 201.

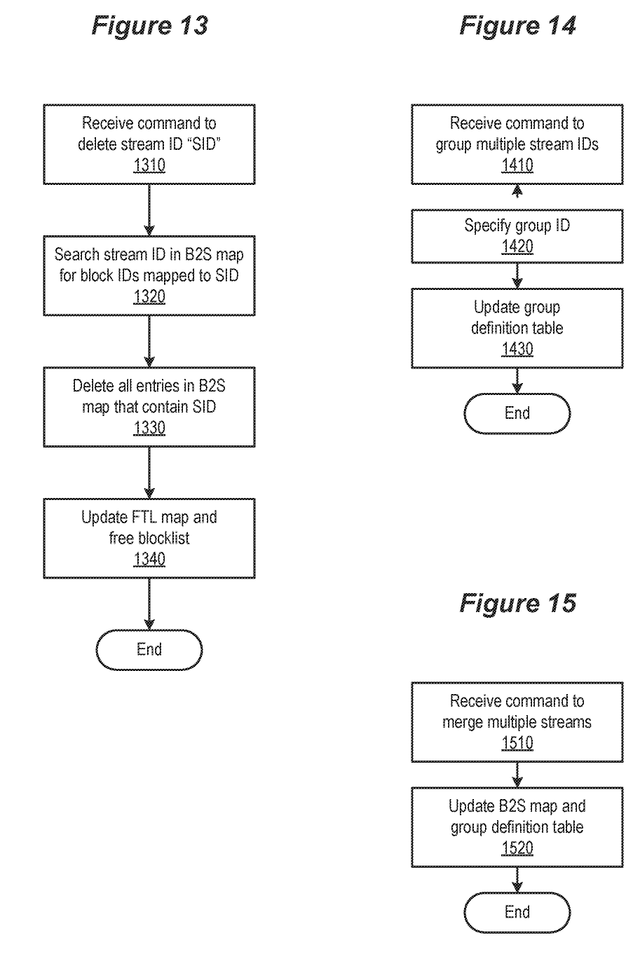

FIG. 13 illustrates a flow diagram of steps performed by drive 100, in particular drive controller 120 of drive 100, when drive controller 120 receives the “delete stream” API. The execution of the “delete stream” API begins at step 1310 when drive controller 120 receives the “delete stream” API that specifies a particular SID. At step 1320, drive controller 120 searches for the particular SID in B2S map 161 to specify physical block IDs that are mapped to the particular SID. Then, drive controller 120 deletes all entries in the B2S map 161 that contain the particular SID (step 1330), and updates FTL map 163 and a free block list (step 1340). For this update, drive controller 120 deletes all entries in FTL map 161 containing the physical block IDs that are mapped to the deleted SID and adds to the free block list the physical block IDs that are mapped to the deleted SID. It should be noted that the actual process of erasing the block can be carried out synchronously with the receipt of this API or at a later time. In response to the “delete stream” API, all blocks of the particular stream are moved to the free block pool.

The “group streams” API has a list of stream IDs, as a parameter. The host 10 may issue the “group streams” API when host 10 attempts to logically group a plurality of stream Ds so that they can be managed collectively, instead of individually managing them.

FIG. 14 illustrates a flow diagram of steps performed by drive 100, in particular drive controller 120 of drive 100, when drive controller 120 receives the “group streams” API. The execution of the “group streams” API begins at step 1410 when drive controller 120 receives the “group streams” API that specifies a plurality of stream IDs. At step 1420, drive controller 120 specifies a group ID from the received stream IDs. If a group ID is not yet assigned to the specified stream Ds, then drive controller 120 allocates a new group ID to the stream IDs. At step 1430, drive controller 120 updates group definition table 163 to associate the specified group ID with the stream IDs specified in the API.

The “merge streams” API has two parameters, one for a list of one or more target stream Ds and the other for a destination stream ID. The host 10 may issue the “merge streams” API when host 10 attempts to logically merge a plurality of stream IDs so that they can be managed collectively, instead of individually managing them.

FIG. 15 illustrates a flow diagram of steps performed by drive 100, in particular drive controller 120 of drive 100, when drive controller 120 receives the “merge streams” API. The execution of the “merge streams” API begins at step 1510 when drive controller 120 receives the “merge streams” API that specifies the target stream IDs and a destination stream ID. At step 1520, drive controller 120 changes all target stream IDs to the destination stream ID in the B2S Map 161 and group definition table 163. As a result, streams corresponding to the target stream IDs are merged into the destination stream.

The “start stream garbage collection” API has one parameter, the stream ID. The host 10 may issue the “start stream garbage collection” API when host 10 attempts to start garbage collection with respect to blocks associated with the specified stream ID. When the garbage collection is started by the “start stream garbage collection” API, active blocks to be collected (target active blocks) are selected from active blocks associated with the specified stream ID, and are not selected from active blocks that are not associated with the specified stream ID. Then, all valid data stored in the target active blocks are transferred to one or more input blocks, for example, an input block associated with the specified stream ID (an arrow F in FIG. 9) or an input block associated with no stream ID (an arrow F′ in FIG. 11)

While the foregoing is directed to embodiments of the present invention, other and further embodiments of the invention may be devised without departing from the basic scope thereof, and the scope thereof is determined by the claims that follow.

What is claimed is:

1. A storage device, comprising:
a nonvolatile semiconductor memory device including a plurality of physical blocks; and
a controller configured to map the physical blocks and access the physical blocks based on mapping thereof, wherein the controller maps
a physical block having space, as a first input block for writing data associated with a first identifier,
another physical block having space, as a second input block for writing data associated with a second identifier,
a physical block that became full of data associated with the first identifier, as a first active block,
a physical block that became full of data associated with the second identifier, as a second active block, and
a physical block that became full of invalid data associated with the first identifier and a physical block that became full of invalid data associated with the second identifier, as free blocks associated with no identifier.

2. The storage device according to claim 1, wherein
the controller is further configured to receive a write command and write data from a host,
when the write command includes the first identifier, the write data are written into the first input block, and not into the second input block, and
when the write command includes the second identifier, the write data are written into the second input block, and not into the first input block.

3. The storage device according to claim 1, wherein
when garbage collection is carried out with respect to the first active block, valid data in the first active block are written into the first input block, and not into the second input block, and
when garbage collection is carried out with respect to the second active block, valid data in the second active block are written into the second input block, and not into the first input block.

4. The storage device according to claim 1, wherein
the controller maps another physical block having space as a third input block associated with no identifier,
when garbage collection is carried out with respect to the first active block, valid data in the first active block are written into the third input block, and not into the first and second input blocks, and
when garbage collection is carried out with respect to the first active block, valid data in the second active block are written into the third input block, and not into the first and second input blocks.

5. The storage device according to claim 1, wherein
data associated with first namespace and data associated with second namespace are both written into the first input block.

6. The storage device according to claim 1, wherein
the controller is further configured to remap the first input block as a third input block associated with no identifier, for writing data associated with no identifier, in response to a close command including the first identifier.

7. The storage device according to claim 1, wherein
the controller is further configured to invalidate all data in the first input block and the first active block and remap the first input block and the first active block as free blocks, in response to a delete command including the first identifier.

8. The storage device according to claim 1, wherein
the controller is further configured to disassociate the first input block and the first active block from the first identifier and associate the first input block and the first active block with the second identifier.

9. A storage device, comprising:
a nonvolatile semiconductor memory device including a plurality of physical blocks; and
a controller configured to map the physical blocks and access the physical blocks based on mapping thereof, wherein the controller maps
a physical block having space, as a first input block for writing data associated with a first identifier,
another physical block having space, as a second input block for writing data associated with a second identifier,
a physical block that became full of data associated with the first identifier and a physical block that became full of data associated with the second identifier, as active blocks associated with no identifier, and
a physical block that became full of invalid data associated with the first identifier and a physical block that became full of invalid data associated with the second identifier, as free blocks associated with no identifier.

10. The storage device according to claim 1, wherein
the controller is further configured to receive a write command and write data from a host,
when the write command includes the first identifier, the write data are written into the first input block, and not into the second input block, and
when the write command includes the second identifier, the write data are written into the second input block, and not into the first input block.

11. The storage device according to claim 9, wherein
the controller maps another physical block having space as a third input block associated with no identifier,
when garbage collection is carried out with respect to the active blocks, valid data in the active blocks are written into the third input block, and not into the first and second input blocks.

12. The storage device according to claim 9, wherein
the controller is further configured to remap the first input block as a third input block associated with no identifier, for writing data associated with no identifier, in response to a close command including the first identifier.

13. The storage device according to claim 9, wherein
the controller is further configured to invalidate all data in the first input block and the first active block and remap the first input block and the first active block as free blocks, in response to a delete command including the first identifier.

14. The storage device according to claim 9, wherein
the controller is further configured to disassociate the first input block and the first active block from the first identifier and associate the first input block and the first active block with the second identifier.

15. A storage device, comprising:
a nonvolatile semiconductor memory device including a plurality of physical blocks; and
a controller configured to map the physical blocks and access the physical blocks based on mapping thereof, wherein the controller maps
a physical block having space, as an input block for writing data associated with any identifiers that are mapped,
a physical block that became full of data associated with said any identifiers, as an active block, and
a physical block that became full of invalid data associated with said any identifiers as a free block.

16. The storage device according to claim 15, wherein
the controller is further configured to receive a write command and write data from a host,
both when the write command includes the first identifier and when the write command includes the second identifier, the write data are written into the input block.

17. The storage device according to claim 15, wherein
when garbage collection is carried out with respect to the active block, valid data associated with a first identifier are transferred to a physical block associated with the first identifier, and valid data associated with a second identifier are transferred to a physical block associated with the second identifier.

18. The storage device according to claim 17, wherein
the controller is further configured to disassociate the physical block associated with the first identifier from the first identifier, in response to a close command including the first identifier.

19. The storage device according to claim 17, wherein
the controller is further configured to invalidate all data in the physical block associated with the first identifier and remap the physical block containing the invalidated data as a free block, in response to a delete command including the first identifier.
